(19) United States
(12) Patent Application Publication
(10) Pub. No.: US 2014/0191926 A1
(43) Pub. Date: Jul. 10, 2014

(54) DEVICE AND METHOD FOR RENDERING CONTENT TO MULTIPLE DISPLAYS

(71) Applicant: QUALCOMM MEMS TECHNOLOGIES, INC., San Diego, CA (US)

(72) Inventors: Mithran Mathew, Mountain View, CA (US); Nathan Ramasarma, San Diego, CA (US)

(73) Assignee: QUALCOMM MEMS Technologies, Inc., San Diego, CA (US)

(21) Appl. No.: 13/829,757

(22) Filed: Mar. 14, 2013

Related U.S. Application Data
(60) Provisional application No. 61/748,862, filed on Jan. 4, 2013.

(51) Int. Cl. G09G 3/00

(52) U.S. Cl. CPC G09G 3/00
USPC 345/1.1

(57) ABSTRACT

This disclosure provides methods and apparatus, including non-transitory processor instructions on computer storage media, which enable a dual-display device to automatically select and render content to a display. Dual-display devices may include devices with a primary and a secondary display, the secondary display consuming less power than the primary display and having reduced glare when viewed in sunlight. In one aspect, the selection of the display may be based upon at least two of: a battery state of the device, an ambient illumination, and an item of content to be displayed.

### CROSS-REFERENCE TO RELATED APPLICATIONS

This patent application claims priority to U.S. Provisional Patent Application No. 61/748,862 filed Jan. 4, 2013 entitled “DISPLAY DEVICES HAVING A PRIMARY DISPLAY AND A SECONDARY DISPLAY,” and assigned to the assignee hereof. The disclosure of the prior application is considered part of and is incorporated by reference in this patent application.

### TECHNICAL FIELD

This disclosure relates to multi-display devices, to methods and systems for selecting display(s) of a multi-display device on which to render content, and to electromechanical systems and devices.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

Different display technologies, including IMOD displays, liquid crystal displays, organic light-emitting diode (“OLED”) displays, and field emission displays have different performance characteristics. These performance characteristics may include viewing angles, refresh rates, contrast ratios, power requirements, and Delta-E measurements. Given the wide variety of customer use cases, it is these differences in display technologies which may disadvantage one display technology over another. As a result, devices are being manufactured which include more than one type of display to provide a user with improved performance across use cases.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method including determining, by a processor of a device, a parameter based at least in part on an algorithm that evaluates at least two of: a battery state of the device, an ambient illumination, and an item of content to be displayed. The method further includes selecting at least one selected display from among a primary display and a secondary display based at least in part on the determined parameter and displaying the item of content on the at least one selected display.

In some implementations, the method can include an algorithm which evaluates the ambient illumination against a light threshold, evaluates a battery charge level against a battery charge threshold, and evaluates the item of content to obtain a content type based at least in part on one or more of whether the item of content is interactive, on an amount of text content relative to an amount of image content in the item of content, on the rate of change of the item of content, or on the resolution of the item of content.

In some implementations, the method can include an algorithm which evaluates a set of rules, in no particular order, which update the parameter. The set of rules can include updating the parameter based on the ambient illumination as measured by a light sensor, updating the parameter based on an amount of text within the item of content, updating the parameter based on an amount of color within the item of content, and updating the parameter based on a charge level obtained from the battery state of the device.

Another innovative aspect of the subject matter described in this disclosure can be implemented in a non-transitory, computer readable storage medium having instructions stored thereon that cause a processing circuit to perform the method described above.

Another innovative aspect of the subject matter described in this disclosure can be implemented in an apparatus including a primary display, a secondary display, and a processor configured to communicate with the primary display and the secondary display, the processor further configured to determine a parameter based at least in part on an algorithm that evaluates at least two of: a battery state of the device, an ambient illumination, an item of content to be displayed, and a setting of the device. The processor being further configured to select at least one selected display from among a primary display and a secondary display based at least in part on the determined parameter and to display the item of content on the selected display.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows several perspective views of a display device with a primary and a secondary display.

FIG. 2 shows a system block diagram illustrating an example display device that includes a primary and a secondary display.

FIG. 3 shows an example of an isometric view depicting two adjacent pixels in a series of pixels of an interferometric modulator display that may be included in the device depicted in FIG. 1.

FIG. 4 shows an example of a system block diagram illustrating an electronic device incorporating a 3×3 interferometric modulator display.

FIG. 5 shows an example of a method that may be used to select display(s) of a multi-display device on which to render an item of content.

FIG. 6 shows an example flowchart of an algorithm that may be used to evaluate on which display to render content on a dual-display device like the one depicted in FIG. 1.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. Thus, the teachings are not intended to be limited to the implementations depicted solely in the Figures, but instead have wide applicability as will be readily apparent to one having ordinary skill in the art.

Various implementations include methods and apparatus, including computer readable medium, that perform display selection for content in a rendering pipeline of a device having multiple displays. The device may include a secondary, low-power display and a primary, higher-power display (e.g., LCD or OLED). In many implementations, the secondary display will be what may be referred to as an “always-on display.” meaning it is only turned off in rare instances as opposed to the primary high power display which is typically timed off in the absence of recent user interaction. The selection may be based on an algorithm which evaluates several factors. These factors may include the battery state of the device, the content type of the content to be rendered, the ambient illumination of the environment in which the device is located, and device settings. Content type evaluation may include evaluating relative amounts of text, image, or video data, including color characteristics, of the content to be rendered.

Particular implementations of the subject matter described in this disclosure can be implemented to realize one or more of the following potential advantages. Application developers may avoid building separate applications for each device based on the device API and the included displays. Instead, the rendering pipeline, including a controller and the algorithm may dynamically assign content to be rendered to an appropriate display. Further, energy consumption may be optimized by rendering appropriate content on a lower power display.

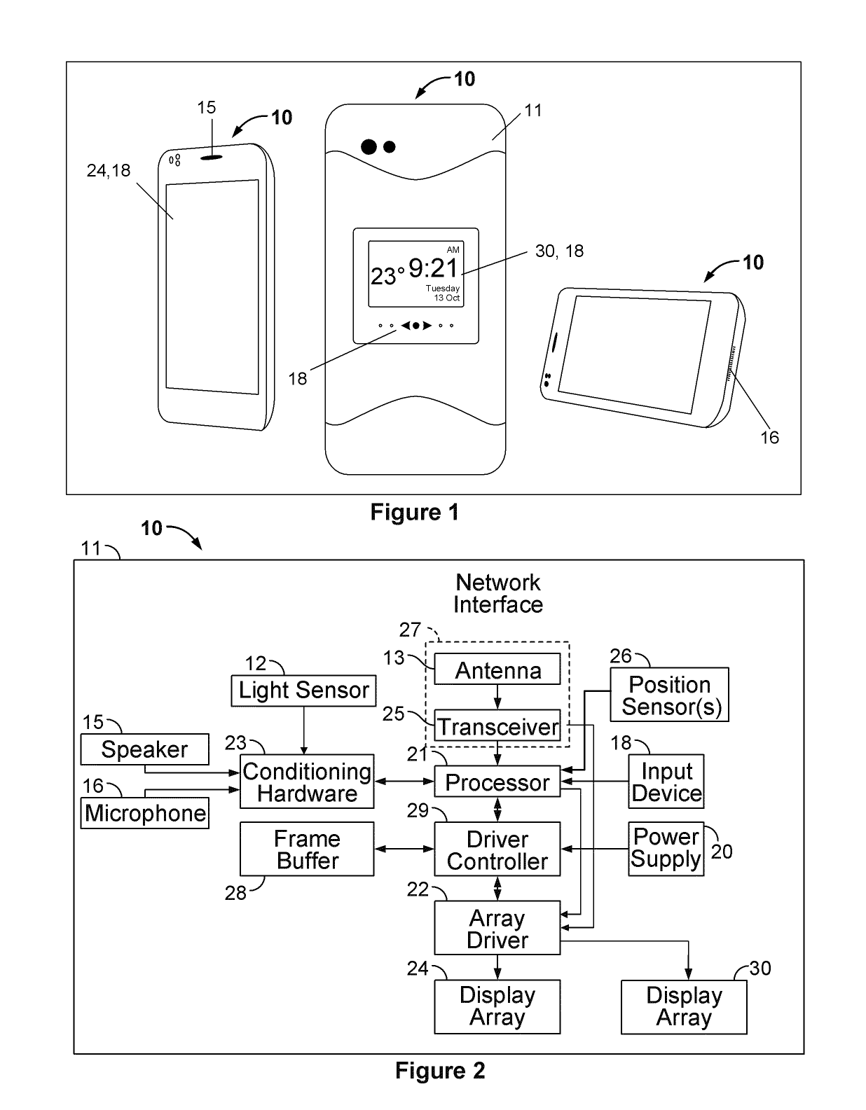

FIGS. 1 and 2 are system block diagrams illustrating a display device that includes two display types. The display device 10 can be, for example, a smart phone, a cellular or mobile telephone. However, the same components of the display device 10 or slight variations thereof are also illustrative of various types of display devices such as televisions, computers, tablets, e-readers, hand-held devices and portable media devices, and other devices as set forth above.

The display device 10 includes a housing 11, a primary display 24, a secondary display 30, an antenna 13, a speaker 15, a light sensor 12, at least one input device 18, and a microphone 16. The housing 11 can be formed from any of a variety of manufacturing processes, including injection molding, and vacuum forming. In addition, the housing 11 may be made from any of a variety of materials, including, but not limited to: plastic, metal, glass, rubber and ceramic, or a combination thereof. The housing 11 can include removable portions (not shown) that may be interchanged with other removable portions of different color, or containing different logos, pictures, or symbols.

The primary display 24 and secondary display 30 may be any of a variety of displays, including a bi-stable or analog display, as described herein, and include an array of display elements. Bi-stable displays may display static content while using almost zero power. The primary display 24 and secondary display 30 also can be configured to include a flat-panel display, such as plasma, EL, OLED, STN LCD, or TFT LCD, or a non-flat-panel display, such as a CRT or other tube device. In addition, the primary display 24 and secondary display 30 can include an interferometric modulator (IMOD) based display, as described herein. In some implementations, the secondary display 30 is an IMOD-based display or reflective display, while the primary display 24 is not an IMOD-based or reflective display. Further, the primary display 24 and secondary display 30 may be located on distinct regions of the display device 10. In the device of FIG. 1, the primary display is on the front face and the secondary display is on the rear face. However, both may be on the same face, and may even share a single region by alternating, in a regular pattern, the display elements of each array within the region. Further, the device may allow the primary display to move relative to the secondary. For example, the device may include a slide or hinge joining the two displays. In many implementations, the primary and secondary display share different advantages in different use conditions. The primary display may be a back or side lit LCD or LED display with high resolution, color reproduction capabilities, and high frame rate. Such a display has excellent performance when viewing media such as video and the like indoors, but suffers from high power consumption and glare when viewed in sunlight. The secondary display may be a reflective display with no need for a light source that has low power consumption and that can be viewed clearly under direct outdoor lighting. While not shown in FIG. 1, the display device 10 may also include a frontlight to illuminate a reflective display or other non-backlit display to allow use during low light conditions.

In some embodiments, the secondary display may be built into an accessory or an interchangeable or removable component. In other words, the secondary display may not be built into the display device as depicted in FIG. 1, but integrated with or built into a display device cover, sleeve, or interchangeable panel. For example, the back panel of the display device may be interchangeable between a panel with a secondary display and a panel without a secondary display. As another example, the secondary display may be built into a protective cover, carrying case, or sleeve for the display device with the primary display.

Each of the primary display 30 and secondary display 24 may have an associated input device 18. In many implementations, the primary display will incorporate a touchscreen for navigating through primary display content and functions of the device as is done in many commercially available display devices. The secondary display 24 may also incorporate a touchscreen. For implementations where the secondary display is small relative to the primary display 30, a touchscreen over the secondary display may be impractical. Thus, in some implementations, such as shown in FIG. 1, the secondary display may have a scroll bar 18 positioned proximate to the secondary display 24 that allows user input gestures such as taps and swipes to be used for navigating through content displayed on the secondary display 24 and/or also controlling the functions performed by the device.

The components of the display device 10 are schematically illustrated in FIG. 2. The display device 10 includes a housing 11 and can include additional components at least partially enclosed therein. For example, the display device 10 includes a network interface 27 that includes an antenna 13 which can be coupled to a transceiver 25. The network interface 27 may be a source for image data that could be displayed on the display device 10. Accordingly, the network interface 27 is one example of an image source module, but the processor 21 and the input device 18 also may serve as an image source module. The transceiver 25 is connected to a processor 21, which is connected to conditioning hardware 23. The conditioning hardware 23 may be configured to condition a signal (such as filter or otherwise manipulate a signal). The conditioning hardware 23 can be connected to a speaker 15, a light sensor 12, and a microphone 16. The processor 21 also can be connected to an input device 18, position sensor 26, and a driver controller 29. The position sensor 26 may include one or more accelerometers to determine the spatial orientation of the device. The position sensor 26 may also include a proximity sensor to determine whether the front, back, or sides of the device are adjacent to another surface. The driver controller 29 can be coupled to a frame buffer 28, and to an array driver 22, which in turn can be coupled to a secondary display array 30. Depending on the electrical characteristics of the primary display array 24 and the array driver 22, the array driver 22 may be further coupled to the primary display array 24 and the secondary display array 30. One or more elements in the display device 10, including elements not specifically depicted in FIG. 2, can be configured to function as a memory device and be configured to communicate with the processor 21. In some implementations, a power supply 20 can provide power to substantially all components in the particular display device 10 design.

The network interface 27 includes the antenna 13 and the transceiver 25 so that the display device 10 can communicate with one or more devices over a network. The network interface 27 also may have some processing capabilities to relieve, for example, data processing requirements of the processor 21. The antenna 13 can transmit and receive signals. In some implementations, the antenna 13 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 13 transmits and receives RF signals according to the Bluetooth® standard. In the case of a cellular telephone, the antenna 13 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 25 can pre-process the signals received from the antenna 13 so that they may be received by and further manipulated by the processor 21. The transceiver 25 also can process signals received from the processor 21 so that they may be transmitted from the display device 10 via the antenna 13.

In some implementations, the transceiver 25 can be replaced by a receiver. In addition, in some implementations, the network interface 27 can be replaced by an image source, which can store or generate image data to be sent to the processor 21. The processor 21 can control the overall operation of the display device 10. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 10. The conditioning hardware 23 may include amplifiers and filters for transmitting signals to the speaker 15, and for receiving signals from the microphone 16 and the light sensor 12. The conditioning hardware 23 may be discrete components within the display device 10, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. The formatted information may be displayed on the primary display array 24, the secondary display array 30, or some combination thereof, based on the methods described herein. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the associated display's x-y matrix of display elements.

In some implementations, the driver controller 29 and the array driver 22 are appropriate for any of the types of displays described herein. For example, the driver controller 29 can be a conventional display controller, a bi-stable display controller (such as an IMOD display element controller), or a controller that can control both a conventional display and a bi-stable display. Additionally, the array driver 22 can be a conventional driver, a bi-stable display driver (such as an IMOD display element driver), or a driver that can drive both a conventional display and a bi-stable display. In certain implementations, the driver controller 29 and/or the array driver 22 may have common or individual circuitry for each included display type. In some implementations, the driver controller 29 can be integrated with the array driver 22. Such an implementation can be useful in highly integrated systems, for example, mobile phones, portable-electronic devices, watches or small-area displays.

In some implementations, the input device 18 can be configured to allow, for example, a user to control the operation of the display device 10. The input device 18 can include a keypad, such as a QWERTY keyboard or a telephone keypad, a button, a switch, a rocker, a touch-sensitive screen, a touch-sensitive screen integrated with at least one of the primary display array 24 and the secondary display array 30, or a pressure- or heat-sensitive membrane. The microphone 16 can be configured as an input device for the display device 10. In some implementations, voice commands through the microphone 16 can be used for controlling operations of the display device 10.

The power supply 20 can include a variety of energy storage devices. For example, the power supply 20 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 20 also can be a renewable energy source, a capacitor, or a solar cell, including a plastic solar cell or solar-cell paint. The power supply 20 also can be configured to receive power from a wall outlet.

The light sensor 12 can be configured to measure the ambient illumination of the environment in which the display device 10 is located. For example, the light sensor 12 may include a photoelectric sensor or ambient light sensor, such as a photodiode, a photoresistor, or the like. The display device 10 may include a camera which also may be used to obtain ambient illumination measurements. The measurement may be converted to a light level or lux based on the sensor characteristics. Because the device may be held in a variety of orientations, and placed in pockets or purses during some time periods, there may be more than one light sensor provided, such as one on each side of the device 10, and multiple measurements can be made to evaluate the current ambient light level. For example, the ambient light level may be considered to be the level associated with the sensor exposed to the brightest illumination. These measurements can be combined with data from accelerometers or the like to correlate light level with orientation. The light sensor(s) may be placed on the device in locations that are not normally covered with the user's hand.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

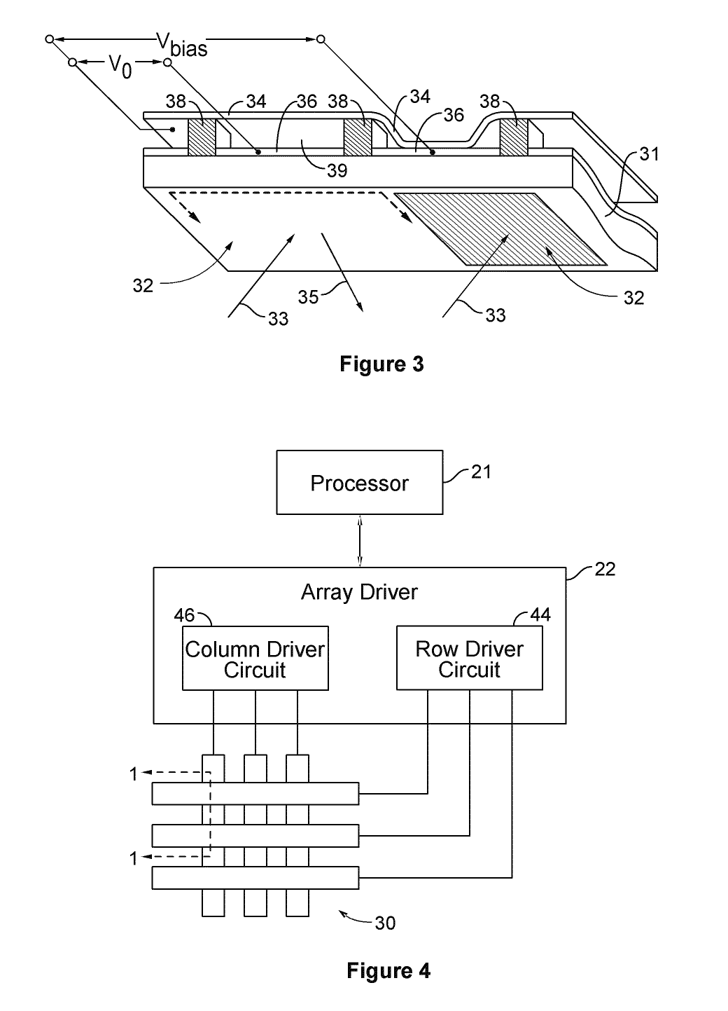

As described above, in some implementations, the secondary display utilizes a display technology that consumes a small amount of power relative to the primary display 30 and is viewed with reflected rather than transmitted light. One such technology that is very suitable for such applications incorporates interferometric modulator display elements. FIG. 3 is an isometric view illustration depicting two adjacent interferometric modulator (IMOD) display elements in a series or array of display elements of a display device 10 that includes an IMOD display. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 3 includes two adjacent interferometric MEMS display elements in the form of IMOD display elements 32. In the display element 32 on the right (as illustrated), the movable reflective layer 34 is illustrated in an actuated position near, adjacent or touching the optical stack 36. The voltage V_{bias} applied across the display element 32 on the right is sufficient to move and also maintain the movable reflective layer 34 in the actuated position. In the display element 32 on the left (as illustrated), a movable reflective layer 34 is illustrated in a relaxed position at a distance (which may be predetermined based on design parameters) from an optical stack 36, which includes a partially reflective layer. The voltage V₀ applied across the display element 32 on the left is insufficient to cause actuation of the movable reflective layer 34 to an actuated position such as that of the display element 32 on the right.

In FIG. 3, the reflective properties of IMOD display elements 32 are generally illustrated with arrows indicating light 33 incident upon the IMOD display elements 32, and light 35 reflecting from the display element 32 on the left. Most of the light 33 incident upon the display elements 32 may be transmitted through the transparent substrate 31, toward the optical stack 36. A portion of the light incident upon the optical stack 36 may be transmitted through the partially reflective layer of the optical stack 36, and a portion will be reflected back through the transparent substrate 31. The portion of light 33 that is transmitted through the optical stack 36 may be reflected from the movable reflective layer 34, back toward (and through) the transparent substrate 31. Interference (constructive and/or destructive) between the light reflected from the partially reflective layer of the optical stack 36 and the light reflected from the movable reflective layer 34 will determine in part the intensity of wavelength(s) of light 35 reflected from the display element 32 on the viewing or substrate side of the device. In some implementations, the transparent substrate 31 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 32 of FIG. 3 and may be supported by a non-transparent substrate.

The optical stack 36 can include a single layer or several layers. The layer(s) can include one or more of an electrode layer, a partially reflective and partially transmissive layer, and a transparent dielectric layer. In some implementations, the optical stack 36 is electrically conductive, partially transparent and partially reflective, and may be fabricated, for example, by depositing one or more of the above layers onto a transparent substrate 31. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 36 can include a single semi-transparent thickness of metal or semiconductor which serves as both a partial optical absorber and electrical conductor, while different, electrically more conductive layers or portions (e.g., of the optical stack 36 or of other structures of the display element) can serve to bus signals between IMOD display elements. The optical stack 36 also can include one or more insulating or dielectric layers covering one or more conductive layers or an electrically conductive/partially absorptive layer.

In some implementations, at least some of the layer(s) of the optical stack 36 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 34, and these strips may form column electrodes in a display device. The movable reflective layer 34 may be formed as a series of parallel strips of a deposited metal layer or layers (orthogonal to the row electrodes of the optical stack 36) to form columns deposited on top of supports, such as the illustrated posts 38, and an intervening sacrificial material located between the posts 38. When the sacrificial material is etched away, a defined gap 39, or optical cavity, can be formed between the movable reflective layer 34 and the optical stack 36. In some implementations, the spacing between posts 38 may be approximately 1-1000 μm, while the gap 39 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 34 remains in a mechanically relaxed state, as illustrated by the display element 32 on the left in FIG. 3, with the gap 39 between the movable reflective layer 34 and optical stack 36. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 34 can deform and move near or against the optical stack 36. A dielectric layer (not shown) within the optical stack 36 may prevent shorting and control the separation distance between the layers 34 and 36, as illustrated by the actuated display element 32 on the right in FIG. 3. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 4 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 44 and a column driver circuit 46 that provide signals to, for example a display array 24 or a display array 30. In the case of an IMOD display device, the cross section of the IMOD display device illustrated in FIG. 3 is shown by the lines 1-1 in FIG. 4. Although FIG. 4 illustrates a 3×3 array of IMOD display elements for the sake of clarity, the display array may contain a very large number of IMOD display elements, and may have a different number of IMOD display elements in rows than in columns, and vice versa. In some implementations, the primary display 24 on a display device is a backlit display or other display characterized by a high resolution, a high contrast, and a low response time. The secondary display 30 may be a low-power display or a sunlight-viewable display such as the display technology described above with reference to FIGS. 3 and 4. In this configuration, the primary display traditionally consumes more power than the secondary display. The above discussion of interferometric display elements provides a description of one suitable example for a secondary display of a device having multiple displays, and Appendix I of this application provides further information regarding interferometric modulator display construction. A variety of other technologies have been developed that share some of the reflective viewing and low power properties of interferometric modulators. These are also suitable for use with the display device implementations described herein. The novel aspects of the display devices described herein are not dependent on the use of any specific display technology, however, and are applicable to any display device with multiple displays regardless of the display type used for any of them.

With display devices that include multiple displays, the device operating system or application developer traditionally selects which display to render content to. For example, the operating system might send calendar reminders to an outer display on a flip-phone type device. As another example, an application developer might specify that particular information be rendered on one display while other information be rendered on another display, per the device API (e.g., gameplay content on one display while game score information on another display.) Still other devices may include more than one display, yet only allow application developers access to a single display. The aforementioned techniques for selecting a display are accomplished without respect to context, device status, local environmental conditions, etc.

To allow for more dynamic, flexible use of the available displays on a display device, a rendering engine may be used, the rendering engine including a controller and an algorithm that automatically determines the display on which to render content. The rendering engine operates within an operating system framework as part of the viewing or rendering layer of software. For example, the rendering engine may be that of HTML5, the iOS Application Framework, the Android Application Framework, or the Microsoft Windows Mobile Application Framework. The rendering engine may automatically scale and render the content for to the selected display. The rendering engine may determine to render content to both displays simultaneously.

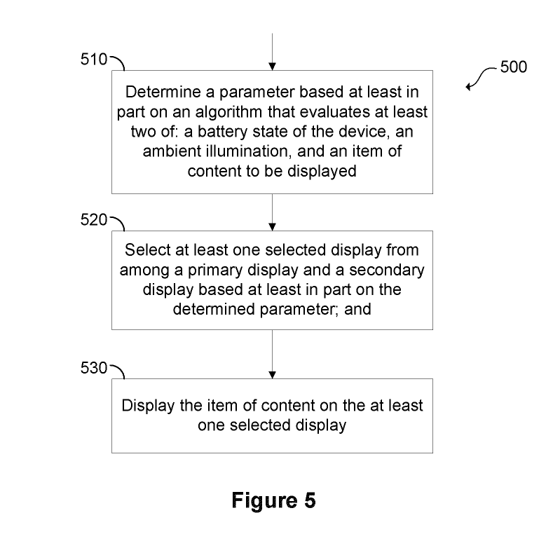

FIG. 5 shows an example of a method that may be used to select a display (or multiple displays) of a multi-display device on which to render an item of content. At block 510, a parameter is determined by a device processor, the parameter being based at least in part on an algorithm that evaluates at least two of the following factors: a content type of the content to be rendered, the battery state of the display device, the ambient illumination of the environment in which the device is located. In some implementations, relevant device settings such as main display brightness, application settings, or privacy settings, may be utilized in the selection process. Using some combination of these factors, at least one display that is utilized for the content is selected. At block 520, a display is selected from among a primary display and a secondary display based at least in part on the determined parameter. At block 530, the item of content is displayed on the selected display.

In evaluating the content type of the content to be rendered, several techniques may be used. For example, the amount of text data may be compared to the amount of image data in the item of content. The level of interactivity of the content may be evaluated, including whether the display device is expecting input via an input device. The delta between subsequent frames and the rate at which frames are updated also may be used to evaluate whether the content is image or video content and thus which display may be more appropriate. The color saturation levels also may be evaluated. Further, the filetype and meta-data of the item of content may be used to obtain information related to the content to be rendered. Based on the content to be rendered, as evaluated by one or more of the aforementioned techniques, the primary display may be preferred for high-interactivity, high-resolution content (e.g., a game). Conversely, the secondary display may be preferred for low-interactivity, predominately text content (e.g., an e-book).

The algorithm may further consider the battery state of the display device. Battery state information may include information relating to the charge level of the battery (e.g., 40%) and whether the battery is presently charging. If the battery is fully charged, or the device is presently charging, the algorithm may prefer the primary display over the secondary display, even where selecting the secondary display would reduce power consumption. Similarly, if the battery is nearly depleted and the device is not charging, the algorithm may prefer the secondary display over the primary display, even where the primary display may be preferred based on content type.

The ambient illumination of the environment in which the device is present may be measured as a light level or lux. Again, the rendering engine may alter the preferred display for a particular item of content based upon the ambient illumination. For example, if the device is in direct sunlight, a reflective sunlight-viewable secondary display may be given preference.

The display device also may allow a user to set display preferences which set a particular display for certain applications or content types. Further, the display device may be configured to select the primary display or the secondary display upon loading a particular item of content and not reevaluate the selection at a later time. Alternatively, the display device may be configured to periodically, or upon the occurrence of an event (e.g., a very low ambient illumination measurement) be configured to reevaluate the display to be used.

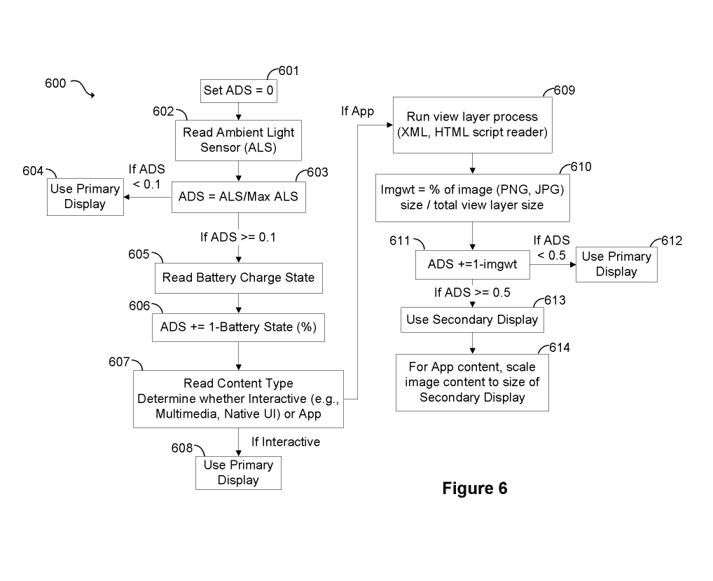

During use of a display device, each of these factors may be relevant to the selection of which display to use, and may in fact be inconsistent with one another. For example, if the light level is low, a backlit primary display is preferred, and if the battery is low, a low power secondary display is preferred. If the light level and battery are both low, some method of arbitrating between the competing factors may be used. FIG. 6 shows an example flowchart of an algorithm that may be used to evaluate on which display to render an item of content on a dual-display (e.g., the display device 10 in FIG. 1). The sequence of steps depicted and the thresholds discussed below serve as examples only, and may be varied or modified depending on a particular implementation. At block 601, a parameter referred to herein as “ADS” is initialized to zero. After reading a value from the ambient light sensor (ALS) at block 602, the measured light level is scaled to the maximum ambient illumination value (for example, the measured value for direct bright sunlight) and the parameter updated to be equal to the scaled measurement at block 603. The value of the ADS parameter has thus become the light level as a fraction of direct outdoor sunlight. If the ambient illumination is such that a secondary display would not be easily visible (e.g. ADS <0.1), a primary display may be selected at block 604 regardless of the state of any other relevant conditions. However, if the secondary display remains a viable selection, at blocks 605 and 606 the battery state may be obtained and the parameter updated based on the percent charge remaining in the battery. In this implementation, 1-(remaining battery charge fraction) may be added to the existing value of the parameter ADS. At block 607 the content to be rendered is evaluated to determine whether it is interactive. Where the display device has a primary display that may serve as an input device such as a touch screen and a secondary display that may not (or may have low resolution touch input capacity), and the content is interactive, the algorithm may select the primary display, as indicated at block 608. This can be determined by checking whether the content being displayed includes slide bars, volume controls, or the like that will likely be manipulated by a user when viewing the content. If it is determined that the content is not interactive, a view layer process may be run at block 609 to obtain additional information related to the content to be displayed. This additional information may include information related to the need for high resolution, color fidelity, and/or fast updates of the content. If the incoming image stream includes a high rate series of moving images, or is a single image with high resolution and/or color depth, the primary display may be preferred. On the other hand, if the image is all or mostly text, the secondary display may be preferred. At block 610, the example algorithm of FIG. 6 evaluates the percentage of image data to be displayed versus the total amount of data to be displayed and, at block 611, increases the parameter based on the percentage of non-image data to be displayed. If the parameter has met a threshold value, in this case 0.5, at blocks 613 and 614 the secondary display may be selected and the content scaled as needed. If, however, the parameter has not met the threshold value, the primary display may be selected, indicated by block 612.

In some implementations, fuzzy logic may be used to capture the balance between different competing factors where, as here, there are multiple non-exclusive factors that may be evaluated to determine the appropriate display for a particular rendering operation. As discussed above, these factors may include the ambient illumination, the amount of text versus image content in an item of content to be rendered, a level of color saturation in the frame buffer, a battery state, and device settings. In such a fuzzy logic implementation, a set of rules may be used to update an objective function, ƒ(n). An exemplary rule set may include the rules listed in Table 1, where periodically, the ADS parameter defined by the function ƒ(n) is set initially to zero and the following ruleset is performed to produce a resulting ADS value that is then used at least in part to select the display for use.

TABLE 1
Example Ruleset

| If | Then | Comment |
|---|---|---|
| ALS <200 lux | f(n) −= 0.5 | Low ambient illumination |
| ALS >1000 lux and <5000 lux | f(n) += 0.5 | Adequate ambient |
| | | illumination |
| ALS >5000 lux | f(n) += 0.7 | High ambient illumination |
| avg(L*ab) color space | f(n) −= 0.3 | High color content |
| ab* >0.7 | | |
| avg(L*ab) color space | f(n) += 0.3 | Low color content |
| ab* <0.4 | | |
| battery_charge >80% | f(n) −= 0.3 | High battery charge |
| battery_charge <20% | f(n) += 0.3 | Low battery charge |
| text_layer and text_layer | f(n) += 0.4 | High text content |
| >50% of full layer size | | |
| no text_layer | f(n) −= 0.4 | No text content |

Of course, the conditional thresholds and parameter updates listed in Table 1 may be tailored or optimized for a particular implementation. Based on the value of ƒ(n), either the primary display or the secondary display may be selected. If ƒ(n) is more negative, the propriety of the primary display may be established, whereas if ƒ(n) is more positive, use of the secondary display may be preferred. Of course, a range encompassing the zero value may indicate that either the primary or the secondary display may be used. In such a case, the algorithm may consider whether the primary or secondary display had previously been selected, and select the same display. Further, to prevent toggling between displays, hysteresis may be used to limit selection of a different display until a certain threshold has been reached (e.g., the primary display is selected once ƒ(n) drops below −0.1 and the secondary display is selected once ƒ(n) rises above +0.1).

A fuzzy logic ruleset as described above may be used as one component of a more complex decision flow as well. For example, the parameter value may only be used to make a rendering decision after it is initially determined that the ambient light level is sufficient for viewing a reflective secondary display. It is also possible for the rendering algorithm to determine to provide the content to both the primary display and the secondary display simultaneously. For example, the ambient light level and other factors may produce a parameter value that indicates that the secondary display is appropriate and render content to the secondary display. The algorithm may then further use the battery level input, and if the battery level is high, the content may appear on both displays so that the user can flip back and forth to view whichever display is most convenient for viewing and/or interacting with the content at any given moment.

In some implementations, the fuzzy logic may apply heuristics to determine behavior based on historical recommendations, actions as suggested by the algorithm, and further by patterns of the user. As one example, if the user overrides the display selected by the algorithm repeatedly for a specific item of or application, the fuzzy logic may apply heuristics to reflect that preference. As another example, if the user performs an action consistently each day (e.g. consciously deciding to view stock tickers on the secondary display as opposed to the primary display), the fuzzy logic could apply heuristics to automatically move the application to the secondary display without user intervention. The “learned” actions may be used to update, modify, or expand the rule set used to determine the appropriate display. Alternatively, the “learned” actions may not be based on the condition of the device and the interdependencies between the rules that determine the appropriate display, alternate rules may be introduced outside of the algorithm. In the latter case heuristics may be applied whether or not the algorithm is using fuzzy logic.

In some embodiments, the algorithm may be tailored to device specific or other application specific parameters or variables. One such variable may be the presence of a frontlight. A frontlight may be included on a device of FIG. 1 (not shown) to illuminate the secondary display during low light conditions. Because a frontlight consumes power, it preferably is kept off even if the intensity of the ambient requires it unless it aids in device usage. The algorithm may factor in the presence of the frontlight and appropriate use conditions in determining whether to select the primary or secondary display and whether to enable the frontlight. For example, if the frontlight aids in viewing the secondary display but the display has not been updated, the algorithm may keep the frontlight off to conserve power. If the user begins to interact with the display, or new information is displayed on the secondary display, the algorithm may turn the frontlight on.

Another variable may be whether the display device includes a position sensor. Data from the position sensor may be used to determine the spatial orientation of the display device or whether the display device may have one or more surfaces adjacent to another surface. For example, one or more accelerometers may be used to determine the spatial orientation of the device. The orientation may be used to scale or adjust the measured ambient illumination by the light sensor. Further, one or more proximity sensors may be used to determine whether the device is next to another surface. For example, the proximity sensor may indicate the device is placed on a desk, preventing at least one of the displays from being viewed, overriding the method of FIG. 5 and algorithm of FIG. 6, and selecting the viewable display.

Another variable may be whether the device carrying the primary and secondary display is used to control a second device such as a remote control for a television or audio system. When a secondary device is used in this manner, the algorithm may give precedence to relevant data or an application (e.g. the remote control application) to be displayed on the secondary display. This may be based on user preferences for the device. In this specific example, the algorithm may include a rule based on whether the dual display device is connected to a second device. If so, the algorithm may display a preferred application or information on the primary and/or secondary displays. Heuristics may further aid in the selection.

In another implementation, the device may have a removable or peripheral secondary display. The algorithm may take into account the user account preferences should two or more users share a removable or peripheral secondary display. If the removable or peripheral secondary display includes a separate power source and stores user preferences, the primary display device may read relevant user settings from the removable or peripheral secondary display based on the subscriber ID of a wireless plan, a device ID such as a MAC address, or some other identification such as SIM-based authentication and configuration.

As another variable, if the dual display device allows both the primary and secondary display to be displayed at the same time, both displays could be utilized simultaneously with the appropriate display chosen for suitable data within the same application. For example, if an application had two major components, where one component changed continuously while the other changed infrequently, the first component may be displayed on the primary display and the second component on the secondary display.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method comprising:
determining, by a processor of a device, a parameter based at least in part on an algorithm that evaluates at least two of: a battery state of the device, an ambient illumination, and an item of content to be displayed;
selecting at least one selected display from among a primary display and a secondary display based at least in part on the determined parameter; and
displaying the item of content on the at least one selected display.

2. The method of claim 1, wherein the secondary display consumes less power than the primary display.

3. The method of claim 1, wherein one of the primary display and the secondary display is a transmissive display, an emissive display, a transflective display, or a reflective display.

4. The method of claim 1, further comprising scaling the item of content for the selected display prior to displaying the item of content.

5. The method of claim 1, wherein the algorithm comprises:
evaluating the ambient illumination against a light threshold;
evaluating a battery charge level against a battery charge threshold; and
evaluating the item of content to obtain a content type based at least in part on one or more of whether the item of content is interactive, on an amount of text content relative to an amount of image content in the item of content, on the rate of change of the item of content, or on the resolution of the item of content.

6. The method of claim 5, wherein the selecting is also based at least in part on a device setting.

7. The method of claim 1, wherein the algorithm comprises:
evaluating a set of rules, in no particular order, which update the parameter, the set of rules including:
updating the parameter based on the ambient illumination as measured by a light sensor;
updating the parameter based on an amount of text within the item of content;
updating the parameter based on an amount of color within the item of content; and
updating the parameter based on a charge level obtained from the battery state of the device.

8. The method of claim 7, wherein the selecting comprises:
selecting the primary display if the parameter is greater than or equal to a first threshold;
selecting the secondary display if the parameter is less than or equal to a second threshold; and
selecting either the primary display or the secondary display, whichever was previously selected, if the parameter is between the first threshold and the second threshold.

9. The method of claim 1, wherein the algorithm further evaluates at least one of: an orientation of the device, whether a surface of the device is adjacent to another surface, and whether the device is controlling another device.

10. An apparatus comprising:
a primary display;
a secondary display; and
a processor configured to communicate with the primary display and the secondary display, the processor further configured to determine a parameter based at least in part on an algorithm that evaluates at least two of: a battery state of the device, an ambient illumination, an item of content to be displayed, and a setting of the device, the processor further configured to select at least one selected display from among a primary display and a secondary display based at least in part on the determined parameter and to display the item of content on the selected display.

11. The apparatus of claim 10, wherein the secondary display consumes less power than the primary display.

12. The apparatus of claim 10, wherein one of the primary display and the secondary display is a transmissive display, an emissive display, a transflective display, or a reflective display.

13. The apparatus of claim 10, wherein the processor is further configured to scale the item of content for the selected display.

14. The apparatus of claim 10, wherein the algorithm comprises:
evaluating the ambient illumination against a light threshold, the ambient illumination as measured by a light sensor;
evaluating a charge level against a charge threshold, the charge level obtained from the battery state of the device; and
evaluating the item of content to obtain a content type based at least in part on whether the item of content is interactive, on an amount of text content relative to an amount of image content in the item of content, on the rate of change of the item of content, or on the resolution of the item of content.

15. The apparatus of claim 10, wherein the secondary display is removable.

16. The apparatus of claim 10, wherein the secondary display stores user preferences.

17. The apparatus of claim 10, wherein the primary display and the secondary display are simultaneously viewable.

18. The apparatus of claim 10, wherein the device includes a frontlight to illuminate at least one of the displays.

19. The apparatus of claim 10, wherein the algorithm comprises:
evaluating a set of rules, in no particular order, which update the parameter, the set of rules including:
updating the parameter based on the ambient illumination as measured by a light sensor;
updating the parameter based on an amount of text within the item of content;
updating the parameter based on an amount of color within the item of content; and
updating the parameter based on a charge level obtained from the battery state of the device.

20. The apparatus of claim 19, wherein the processor selection comprises:
selecting the primary display if the parameter is greater than or equal to a first threshold;
selecting the secondary display if the parameter is less than or equal to a second threshold; and
selecting either the primary display or the secondary display, whichever was previously selected, if the parameter is between the first threshold and the second threshold.

21. The apparatus of claim 10, wherein the algorithm further evaluates at least one of: an orientation of the device, whether a surface of the device is adjacent to another surface, and whether the device is controlling another device.

22. A non-transitory, computer readable storage medium having instructions stored thereon that cause a processing circuit to perform a method comprising:
determining, by a processor of a device, a parameter based at least in part on an algorithm that evaluates at least two of: a battery state of the device, an ambient illumination, an item of content to be displayed, and a setting of the device;
selecting at least one selected display from among a primary display and a secondary display based at least in part on the determined parameter; and
displaying the item of content on the selected display.

23. The computer readable storage medium of claim 22, wherein the method further comprises scaling the item of content for the selected display prior to displaying the item of content.

24. The computer readable storage medium of claim 22, wherein the algorithm comprises:
evaluating the ambient illumination against a light threshold, the ambient illumination as measured by a light sensor;
evaluating a charge level against a charge threshold, the charge level obtained from the battery state of the device; and
evaluating the item of content to obtain a content type based at least in part on whether the item of content is interactive, on an amount of text content relative to an amount of image content in the item of content, on the rate of change of the item of content, or on the resolution of the item of content.

25. The computer readable storage medium of claim 24, wherein the selecting is also based at least in part on a device setting.

26. The computer readable storage medium of claim 22, wherein the algorithm comprises:
evaluating a set of rules, in no particular order, which update the parameter, the set of rules including:
updating the parameter based on the ambient illumination as measured by a light sensor;
updating the parameter based on an amount of text within the item of content;
updating the parameter based on an amount of color within the item of content; and
updating the parameter based on a charge level obtained from the battery state of the device.

27. The computer readable storage medium of claim 22, wherein the selecting comprises:
selecting the primary display if the parameter is greater than or equal to a first threshold;
selecting the secondary display if the parameter is less than or equal to a second threshold; and
selecting either the primary display or the secondary display, whichever was previously selected, if the parameter is between the first threshold and the second threshold.

28. The computer readable storage medium of claim 22 wherein the algorithm further evaluates at least one of: an orientation of the device, whether a surface of the device is adjacent to another surface, and whether the device is controlling another device.
